(19) United States
(12) Patent Application Publication
(10) Pub. No.: US 2015/0103764 A1
(43) Pub. Date: Apr. 16, 2015

(54) METHOD AND DEVICE FOR MANAGING COORDINATED MULTI-POINT

(71) Applicant: Alcatel Lucent, Boulogne Billancourt (FR)

(72) Inventors: Yun Deng, Shanghai (CN); Feng She, shanghai (CN); Seau Sian Lim, Swindon (GB)

(73) Assignee: ALCATEL LUCENT, Boulogne Billancourt (FR)

(21) Appl. No.: 14/385,983

(22) PCT Filed: Mar. 18, 2013
(86) PCT No.: PCT/IB2013/000601

§ 371 Date: Sep. 17, 2014

(30) Foreign Application Priority Data
Mar. 19, 2012 (CN) 201210074085.9

(51) Int. Cl. H04W 24/10; H04L 5/00

(52) U.S. Cl. CPC H04W 24/10; H04L 5/0035
USPC 370/329

(57) ABSTRACT

The invention provides a method and a device for measuring enhanced Reference Signal Received Power (eRSRP) of Channel State Information-Reference Signals (CSI-RSs) of transport points in Coordinated Multi-Point (CoMP), and a method and a device for maintaining a measurement set/cooperating set based on the measurement. A method for reporting eRSRP is provided, including: receiving CSI-RSs transmitted by multiple transport points; measuring and evaluating eRSRP of the CSI-RSs of the multiple transport points based on measurement configuration; and transmitting a measurement report about the eRSRP of the measured CSI-RS. The measurement problem of the enhanced reference signal power of the transport points in CoMP and the maintenance problem of the measurement set/cooperating set are solved, thereby greatly promoting the development and application of the CoMP technology.

### BACKGROUND OF THE INVENTION

1. Field of the Invention

The present invention relates to a method and a device for managing Coordinated Multi-Point (CoMP), and in particular, to a method and a device for managing a CoMP measurement set or cooperating set based on a measurement report of a User Equipment (UE).

2. Description of the Prior Art

CoMP transmission is a prospecting technology in the Long Term Evolution-Advanced (LTE-Advanced) project. It can effectively reduce inter-cell interference (ICI) and improve the coverage of high data rate, the cell edge throughput, and/or system throughput. The coordination can be implemented between homogenerous or heterogeneous networks.

An important scenario confirmed in the 3rd Generation Partnership Project (3GPP) is that, in the coverage of a macro cell, a transport/receiving point created by each Remote Radio Head (RRH) has the same cell identifier with a macro cell. In this scenario, the network can use one or more transmission ports to transmit data to or receive data from a UE. To facilitate the CoMP configuration and to prevent the network from collapsing, the network needs to select proper ports to establish a cooperating set according to measurement information about these ports provided by the UE, and maintain the cooperating set.

According to current protocol specifications, Reference Signal Received Power (RSRP) is defined as a linear average of power contributions of resources that bear Cell-specific Reference Signals (CRSs) in the measurement frequency band. In short, only measurement for the RSRP of the CRS is provided. For example, according to the specification TS36.211[3] in the 3GPP, the CRS mapped on an antenna port 0 is used to determine the RSRP. If the UE can reliably detect the CRS mapped on an antenna port 1, the CRS mapped on the antenna port 1 can also be used to determine the RSRP jointly. In the above important scenario, none of the RRHs transmits the CRS, so the UE cannot obtain path loss values of different RRHs, and the base station administered by the macro cell cannot select a proper CoMP cooperating set or CoMP measurement set for the UE. Therefore, it is necessary to develop a measurement mechanism capable of distinguishing different RRHs so as to assist the base station in managing the multi-point cooperating set or measurement set.

### SUMMARY OF THE INVENTION

The present invention provides a method and a device for measuring enhanced RSRP (eRSRP) of channel state information reference signals (CSI-RSs) of transport points in CoMP, and a method and a device for maintaining a cooperating set based on the measurement, so as to obtain and manage channel state of each transport point.

An embodiment of the present invention provides a method for reporting eRSRP, including: receiving CSI-RSs transmitted by multiple transport points; measuring and evaluating eRSRP of the CSI-RSs of the multiple transport points based on measurement configuration; and transmitting a measurement report about the eRSRP of the measured CSI-RSs.

Accordingly, another embodiment of the present invention provides a method for maintaining a CoMP measurement set or cooperating set, including: receiving an eRSRP measurement report; and maintaining the cooperating set based on the received eRSRP measurement report.

In an embodiment, a measurement event in the measurement configuration includes determining whether the eRSRP of the measured CSI-RS of the transport point is better than a threshold, or whether the measured eRSRP of the CSI-RS of the transport point is higher than strongest eRSRP by a preset offset. According to another embodiment, the measurement event further includes determining a transport point with strongest eRSRP through measurement, and then comparing the eRSRP of CSI-RSs of other transport points with the strongest eRSRP. When an exit condition of the two measurement events is satisfied, the measurement report is triggered. In an embodiment, a measurement event in the measurement configuration includes a measurement event A2, A3 or A4 based on protocol TS36.331, and the measurement configuration includes indication information for CSI-RS measurement. After the indication information for CSI-RS measurement is received, the measured eRSRP of the CSI-RS is used for evaluating an entrance condition of the measurement event A2, A3 or A4. In addition, when an exit condition of the measurement event A4 is satisfied, the measurement report is triggered. According to an embodiment of the present invention, evaluating eRSRP of the CSI-RSs of the multiple transport points includes: when a UE detects that the eRSRP of the CSI-RS of at least one of the multiple transport points satisfies an entrance condition of the measurement event, the UE transmits a measurement report to a base station. In another embodiment, when a state that entrance condition of the measurement event is satisfied lasts for TimeToTrigger or longer, the UE transmits the measurement report to the base station. In addition, in an embodiment, setting of S-measure is neglected during measurement and evaluation on eRSRP of the CSI-RSs of the multiple transport points, and when a cell-specific RSRP of a main cell exceeds S-measure, measurement on the eRSRP of the CSI-RSs of the multiple transport points is still performed.

An embodiment of the present invention further provides a UE, including: a CSI-RS receiving device, a measurement device measuring and evaluating eRSRP of CSI-RSs of multiple transport points based on measurement configuration; and a measurement report transmission device.

Another embodiment of the present invention provides a base station, including a measurement report receiving device receiving an eRSRP measurement report; and a cooperating set maintenance device maintaining the measurement set/cooperating set based on the received eRSRP measurement report.

The method and device for measuring eRSRP of CSI-RSs of transport points in CoMP, and the method and device for maintaining a measurement set/cooperating set based on the measurement solve the current problem that reference signal power of transport points in CoMP cannot be obtained, and the method and device are applicable to movement and interference management of the UE, and will promote further development and application of the CoMP technology.

### BRIEF DESCRIPTION OF THE DRAWINGS

FIG. 1 is a flow chart of a method for measuring and reporting eRSRP of CSI-RSs of transport points/cooperating points in CoMP according to an embodiment;

FIG. 2 is a flow chart of a method for maintaining a CoMP cooperating set according to an embodiment of the present invention; and

FIG. 3 is a structural block diagram of a communication system for maintaining a CoMP cooperating set according to an embodiment of the present invention.

### DETAILED DESCRIPTION

For better comprehension of the spirit of the present invention, exemplary embodiments of the present invention are further described in detail below.

Unlike the prior art in which only one cell or only one transport point in the same cell provides a service for a UE, in a CoMP communication system, several cells or several transport points in the same cell provide a service for a UE. Coordinated cells or coordinated transport points in the same cell form a cooperating set that provides the UE with a CoMP solution. Generally, these cells belong to the same frequency band. In non-CoMP, the UE does not need to receive data from multiple cells in the same frequency band or from multiple transport points in the same cell; instead, the UE only needs to receive a Physical Downlink Shared Channel (PDSCH) and a Physical Downlink Control Channel (PDCCH) from a single cell (namely, a main cell). In another aspect, in the existing specifications, RSRP is measured merely based on the CRS and, as a result, a measurement report for RSRP of different transport points cannot be provided, and the RSRP cannot be used for maintaining CoMP.

It should be noted that with the development of technologies and update of standards, components with the same function usually have different names. For example, in LTE, for those skilled in the art, the connotation of a transport point generally includes transport point, port, RHH, and so on. In CoMP, the transport point and the cooperating point are also used in alternation. The technical terms used in the specification of the present invention patent application are for illustrating and demonstrating the technical solution of the present invention. The technical terms are subject to functions in consensus in the technical field, and should not be interpreted arbitrarily according to the names thereof.

An embodiment of the present invention provides a measurement mechanism for eRSRP of CSI-RSs of transport points/cooperating points in CoMP, and maintenance for CoMP configuration based on the measurement. The eRSRP is different from the conventional RSRP, and is not limited to measurement on the CRS; instead, the eRSRP can be used for measurement of any reference signal, and includes RSRP and/or reference signal received quality.

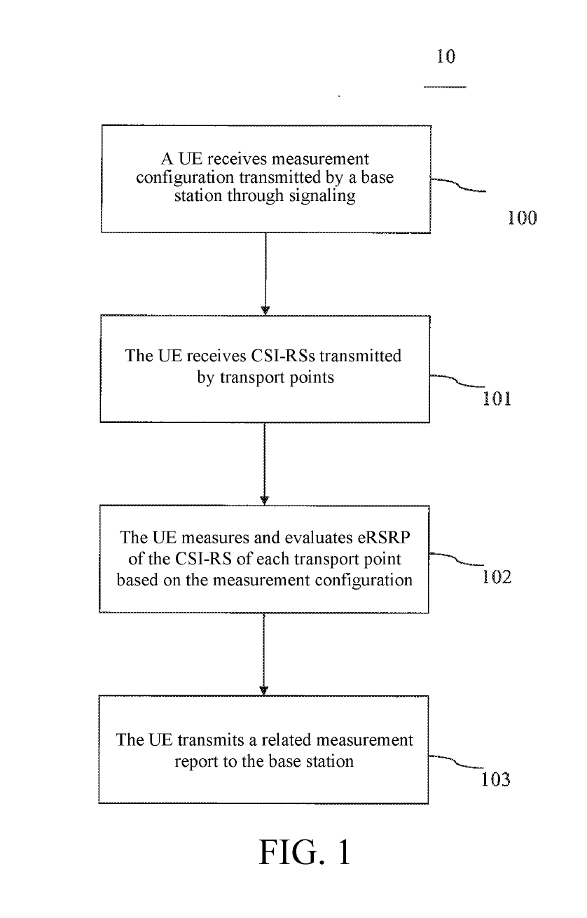

FIG. 1 is a flow chart of a method 10 for measuring and reporting eRSRP of CSI-RSs of transport points/cooperating points in CoMP according to an embodiment. In LTE-10, the CSI-RS has been introduced into the Multiple Input Multiple Output (MIMO), and can be transmitted at one, two, four or eight ports. Specific measurement and reporting are completed by a UE.

In Step 100, a UE receives measurement configuration transmitted by a base station through signaling, where the measurement configuration indicates the UE to measure eRSRP of CSI-RSs of multiple transport points. These transport points may or may not belong to a CoMP measurement set of the UE. The CoMP measurement set refers to a set of transport points whose channel state information such as Channel Quality Indicator (CQI) and Precoding Matrix Indicator (PMI) needs to be fed back by a UE in a physical layer. The UE performing measurement according to the measurement configuration refers to that layer 3 (an upper layer of the physical layer) performing the measurement. The measurement configuration may indicate the UE to measure the eRSRP of the CSI-RSs of the multiple transport points even if cell-specific RSRP of a main cell exceeds S-measure, or may not include such an indication. Through a predefinition of protocol specifications, the UE may still measure, without being indicated by the measurement configuration, the eRSRP of the CSI-RSs of the multiple transport points even if cell-specific RSRP of a main cell exceeds S-measure. The main cell refers to a cell that provides non-access layer movement information (such as location area identification) for the UE, and also refers to a cell with which the UE keeps a Radio Resource Control (RRC) connection. According to the prior art, if the serving base station configures S-measure for the UE, the base station may control whether the UE needs to measure a neighboring cell. Once the RSRP of the main cell is higher than the S-measure, the UE may not perform measurement on the neighboring cell. However, in practice, in order to determine a coordinating transport point or a coordination scheme (Joint Transmission (JT), dynamic point selection, or Coordinated Scheduling/Beamforming (CS/CB)), even if the RSRP of the serving cell is higher than S-measure, the UE still needs to measure eRSRP of CSI-RSs of multiple transport points; otherwise, it is impossible for the serving base station to know which transport point is appropriate for data transmission of the UE, and it is impossible to maintain the cooperating set/CoMP measurement set for the UE.

After receiving the measurement configuration, the UE considers a measurement object, namely, a frequency to be measured. Further, the UE needs to determine CSI-RSs to be measured. In Step 101, the UE receives CSI-RSs transmitted by transport points.

Then in Step 102, the UE measures and evaluates eRSRP of the CSI-RS of each transport point based on measurement configuration. The UE evaluates a measurement result according to an entrance condition or an exit condition of a measurement event. Once it is detected that the CSI-RS measurement result of one or more transport points satisfies the entrance condition (or this state lasts for a period of time which is referred to as TimeToTrigger), the UE lists the measurement result into a measurement report and transmits the measurement report to the base station. That is, only when the entrance condition of the measurement event is satisfied and this state lasts for TimeToTrigger or longer, the UE transmits the measurement report to the base station. According to an embodiment of the present invention, the measurement event may determine whether the eRSRP of the measured CSI-RS of the transport point is better than a threshold, or whether the measured eRSRP of the CSI-RS of the transport point is smaller than strongest eRSRP (or whether the measured eRSRP of the CSI-RS of the transport point is higher than strongest eRSRP by a preset offset, where the offset is a negative value). If the former event is adopted, the measurement configuration includes the threshold, and may also include a CSI-RS specific offset, where the CSI-RS specific offset is used for compensating eRSRP of different transport points. If the latter event is adopted, the UE needs to determine, through comparison, a transport point of which the CSI-RS has the strongest eRSRP among these transport points, and then compare eRSRP values of other CSI-RSs with the strongest eRSRP value. Both measurement events are novel ones not defined in the current protocol. It should be noted that, in the case of inter-cell CoMP, the transport point with the strongest eRSRP is the main cell, and at this time, the measurement event becomes determining whether the eRSRP of CSI-RSs of other cells is higher than the eRSRP of the main cell by a preset offset. The measurement event may also be a measurement event A2, A3 or A4 based on the current protocol TS36.331. In this case, the UE needs to receive a measurement identity including a new triggering amount from the base station, where the new triggering amount is also in the measurement configuration. A measurement object corresponding to the measurement identity indicates multiple CSI-RSs to be measured. The measurement object includes a new Information Element (IE) used for indicating different CSI-RSs, and may also include a CSI-RS specific offset, so as to adjust the measured eRSRP value when the UE evaluates the measurement result. In this case, when receiving the measurement identity, the UE will find the new triggering amount (which may be set to eRSRP) set for the measurement of eRSRP of CSI-RSs, thereby measuring eRSRP of CSI-RSs from different transport points. For a measurement event A4, it is set that the measurement report is triggered when the exit condition thereof is satisfied, which requires a new indication in the measurement configuration to indicate that: if the eRSRP of the CSI-RS of some transport point is lower than the threshold, the UE triggers the measurement report.

In Step 103: the UE transmits the related measurement report to the base station, and in the measurement report, the measured eRSRP value of the CSI-RS is linked to a corresponding CSI-RS identifier to as to distinguish the CSI-RS.

According to an embodiment of the present invention, the measurement configuration may also include a report-on-leave mechanism. If the measurement configuration includes a valid report-on-leave (the report-on-leave is set to True), the UE finds a transport point that satisfies the exit condition of the measurement event in the measurement evaluation. The UE needs to report the measurement report, and reports the transport point that still satisfies the entrance condition of the measurement event currently and the corresponding eRSRP to the base station. If the measurement configuration does not include a report-on-leave mechanism, a new indication is added in the measurement configuration to indicate that when the exit condition of the measurement event is satisfied (for example, the eRSRP of CSI-RS resources is poorer than the threshold, or the eRSRP of CSI-RS resources is greater than the offset of the strongest eRSRP), the UE also reports the measurement report to the base station. For one or more transport points that satisfy the exit condition, the serving base station deletes the transport point(s) from the CoMP measurement set/cooperating set, that is, the serving base station removes the transport point(s) from the CoMP measurement set thereby eliminating the transport point(s) from the cooperating set. It should be noted that, for the measurement event A2, according to an embodiment of the present invention, the serving base station may reuse the measurement event A2 as an enhanced A2. The current A2 measurement is directed to the main cell, while the enhanced A2 is directed to the transport points in the CoMP cooperating set/measurement set. When receiving the measurement report of the enhanced measurement event A2, the serving base station needs to remove the cooperating point (transport point) from the current CoMP cooperating set/measurement set. Once the UE receives the enhanced A2, the UE measures the eRSRP of the CSI-RSs of the transport points in the CoMP measurement set. Once the entrance condition of the A2 is satisfied (that is, the eRSRP of the transport point is lower than the preset threshold), the UE needs to send the measurement report to the base station.

In addition, according to an embodiment of the present invention, test configuration includes TimeToTrigger. The present invention is directed to measurement on eRSRP of CSI-RSs rather than inter-cell movement processing. Therefore, when performing measurement, the UE does not adjust the TimeToTrigger according to the UE speed. When the UE evaluates that the entrance condition or exit condition of the measurement event is satisfied, the UE uses the TimeToTrigger in the measurement configuration. The TimeToTrigger is not adjusted according to the moving speed of the UE. The moving state of the UE does not affect the measurement of eRSRP. However, in the prior art, the measurement event is used for movement management; the UE adjusts the TimeToTrigger configured by the base station according to the moving speed of the UE. For example, the UE detects the movement state and adjusts the TimeToTrigger according to the specifications in TS36.304, and evaluates the measurement object by using the adjusted value.

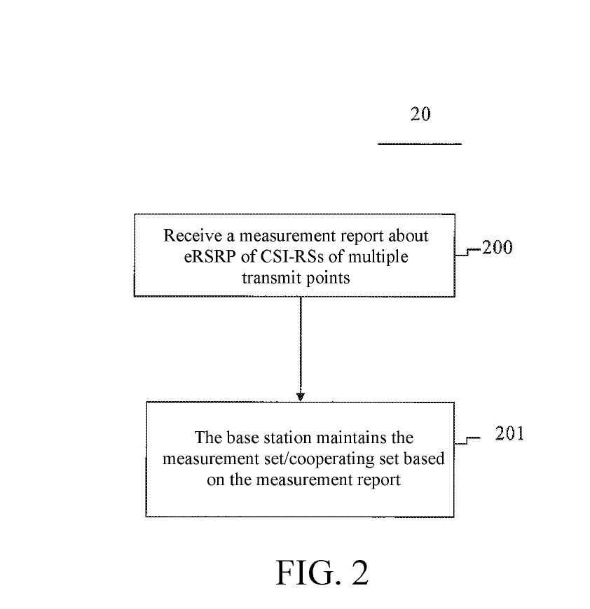

In the present invention, the base station sends the measurement configuration to the UE, so as to measure eRSRP of the CSI-RSs, and meanwhile the measurement configuration is also used for the movement and interference management thereof. On the other hand, the base station can quickly get familiar with definite channel environments of different transport ports based on the received measurement report. FIG. 2 is a flow chart of a method 20 for maintaining a CoMP cooperating set according to an embodiment of the present invention. In Step 200, a base station receives, from a UE, a measurement report about eRSRP of CSI-RSs of multiple transport points. In Step 201, the base station maintains the cooperating set/measurement set based on the measurement report, and maintains (configures), for the UE, the cooperating set/measurement set that provides CoMP for the UE: adding or maintaining a more appropriate transport point in the cooperating set, and eliminating a transport point with a poor channel state from the cooperating set/transport set. The base station configures a CoMP measurement set for the UE according to the measurement report so that the UE feeds back other measurement results, such as PMI, apart from the eRSRP of the CSI-RSs, thereby reporting short-term CSI on a physical uplink control channel or a physical uplink shared channel.

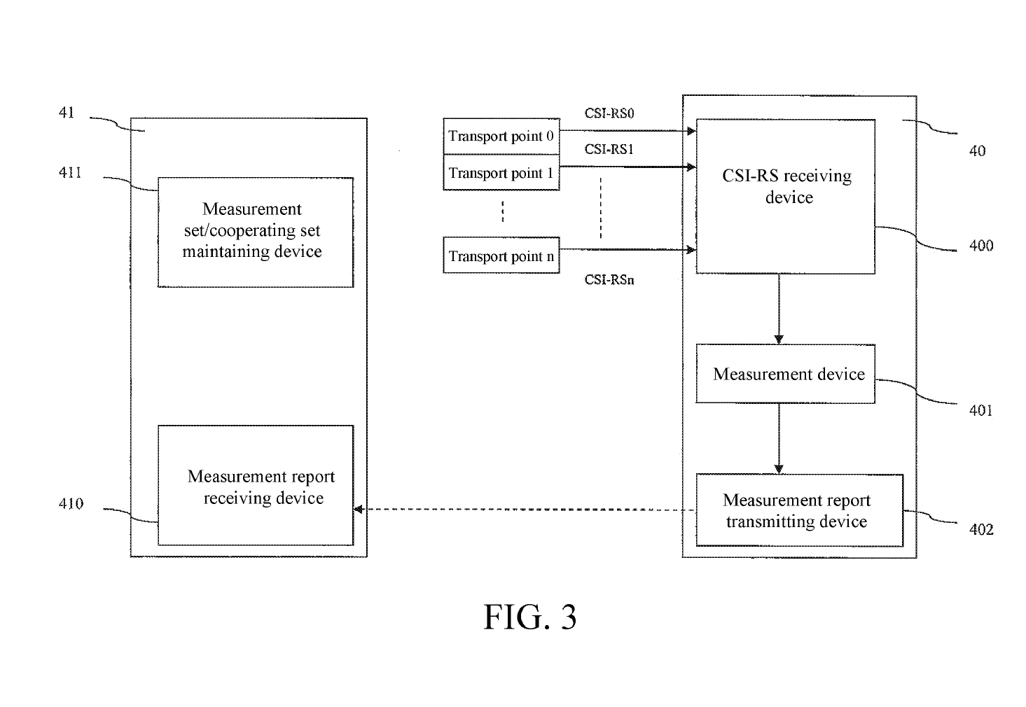

FIG. 3 is a structural block diagram of a communication system for maintaining a CoMP measurement set/cooperating set according to an embodiment of the present invention. In the communication system, the UE 40 includes: a CSI-RS receiving device 400, used for receiving CSI-RSs transmitted by multiple transport points/cooperating points; a measurement device 401, used for measuring and evaluating, based on measurement configuration, eRSRP of the CSI-RSs transmitted by multiple transport points/cooperating points; and a measurement report transmission device 402, used for transmitting a measurement report about the measured eRSRP of the CSI-RSs. Correspondingly, the base station 41 includes a measurement report receiving device 410, used for receiving an eRSRP measurement report; and a cooperating set maintaining device 411, used for maintaining the measurement set/cooperating set based on the received eRSRP measurement report.

The present invention provides a method and a device for measuring and reporting eRSRP of the CSI-RS of each transport point in the CoMP, and a method and a device for maintaining the measurement set/cooperating set based on the related measurement report, thereby solving the problems in the prior art, and facilitating further development and implementation of the CoMP technology.

The technical content and technical features of the present invention are disclosed above. However, those skilled in the art can make various replacements and modifications without departing from the spirit of the present invention based on the teaching of the present invention. Therefore, the protection scope of the present invention is not limited to the disclosure of the embodiments, but includes all replacements and modifications not departing from the present invention, and shall be covered by the claims of the present patent application.

We claim:

1. A method for reporting enhanced Reference Signal Received Power (eRSRP), the method comprising:
receiving Channel State Information-Reference Signals (CSI-RSs) transmitted by multiple transport points;
measuring and evaluating, based on measurement configuration, eRSRP of the CSI-RSs transmitted by the multiple transport points; and
transmitting a measurement report about the eRSRP of the measured CSI-RS.

2. The method according to claim 1, wherein a measurement event in the measurement configuration is determining whether the eRSRP of the CSI-RS of the measured transport point is better than a threshold, or determining whether the eRSRP of the CSI-RS of the measured transport point is higher than strongest eRSRP by a preset offset.

3. The method according to claim 2 further comprising determining a transport point with the strongest eRSRP through measurement, and then comparing the eRSRP of CSI-RSs of other transport points with the strongest eRSRP.

4. The method according to claim 2 further comprising triggering the measurement report when an exit condition of the two measurement events is satisfied.

5. The method according to claim 1, wherein a measurement event in the measurement configuration is a measurement event A2, A3 or A4 based on protocol TS36.331, and the measurement configuration comprises indication information for CSI-RS measurement.

6. The method according to claim 5, wherein after receiving the indication information for CSI-RS measurement, the eRSRP for CSI-RS measurement is used for evaluating an entrance condition of the measurement event A2, A3 or A4.

7. The method according to claim 5 further comprising triggering the measurement report when an exit condition of the measurement event A4 is satisfied.

8. The method according to claim 1, wherein evaluating the eRSRP of the CSI-RS s of multiple transport points comprises:
when detecting that the eRSRP of the CSI-RS of at least one of the multiple transport points satisfies an entrance condition of a measurement event, the UE transmitting the measurement report to a base station.

9. The method according to claim 1, wherein evaluating the eRSRP of the CSI-RSs of multiple transport points comprises:
when detecting that the eRSRP of the CSI-RS of at least one of the multiple transport points satisfies an entrance condition of a measurement event, which lasts for TimeToTrigger or longer, the UE transmitting the measurement report to a base station.

10. The method according to claim 1 further comprising:
neglecting setting of S-measure during measurement and evaluation on the eRSRP of the CSI-RSs of the multiple transport points, and still measuring the eRSRP of the CSI-RSs of the multiple transport points when cell-specific Reference Signal Received Power (RSRP) of a main cell exceeds the S-measure.

11. A method for maintaining a Coordinated Multi-Point (CoMP) cooperating set or measurement set, the method comprising:
receiving an enhanced Reference Signal Received Power (eRSRP) measurement report, wherein the measurement report is about eRSRP of Channel State Information-Reference Signals (CSI-RSs) of multiple transport points measured based on measurement configuration; and
maintaining the cooperating set or measurement set based on the received eRSRP measurement report.

12. The method according to claim 11, wherein a measurement event in the measurement configuration is determining whether the eRSRP of the CSI-RS of the measured transport point is better than a threshold, or determining whether the eRSRP of the CSI-RS of the measured transport point is higher than strongest eRSRP by a preset offset.

13. The method according to claim 11, a measurement event in the measurement configuration is a measurement event A2, A3 or A4 based on protocol TS36.331, and the measurement configuration comprises indication information for CSI-RS measurement.

14. A user equipment (UE) for reporting enhanced Reference Signal Received Power (eRSRP), comprising:
a State Information-Reference Signal (CSI-RS) receiving device receiving CSI-RSs transmitted by multiple transport points;
a measurement device measuring and evaluating eRSRP of the CSI-RSs of the multiple transport points based on measurement configuration; and
a measurement report transmission device transmitting a measurement report about the eRSRP of the measured CSI-RS.

15. The UE according to claim 14, wherein a measurement event in the measurement configuration is determining whether the eRSRP of the CSI-RS of the measured transport point is better than a threshold, or determining whether the eRSRP of the CSI-RS of the measured transport point is higher than strongest eRSRP by a preset offset.

16. The UE according to claim 15 configured to determine a transport point with strongest eRSRP through measurement, and then compare the eRSRP of CSI-RSs of other transport points with the strongest eRSRP.

17. The UE according to claim 15 configured to trigger the measurement report when an exit condition of the two measurement events is satisfied.

18. The UE according to claim 14, wherein a measurement event in the measurement configuration is a measurement event A2, A3 or A4 based on protocol TS36.331, and the measurement configuration comprises indication information for CSI-RS measurement.

19. The UE according to claim 18 configured to, after receiving the indication information for CSI-RS measurement, use the eRSRP for CSI-RS measurement to evaluate an entrance condition of the measurement event A2, A3 or A4.

20. The UE according to claim 18 configured to trigger the measurement report when an exit condition of the measurement event A4 is satisfied.

21. The UE according to claim 14, wherein evaluating the eRSRP of the CSI-RSs of multiple transport points comprises:
when the UE detects that the eRSRP of the CSI-RS of at least one of the multiple transport points satisfies an entrance condition of a measurement event, transmitting the measurement report to a base station.

22. The UE according to claim 14, wherein evaluating the eRSRP of the CSI-RSs of multiple transport points comprises:
when detecting that the eRSRP of the CSI-RS of at least one of the multiple transport points satisfies an entrance condition of a measurement event, which lasts for TimeToTrigger or longer, transmitting the measurement report to a base station.

23. The UE according to claim 14 configured to:
neglect setting of S-measure during measurement and evaluation on the eRSRP of the CSI-RSs of the multiple transport points, and still measure the eRSRP of the CSI-RSs of the multiple transport points when cell-specific Reference Signal Received Power (RSRP) of a main cell exceeds S-measure.

24. A base station for maintaining a Coordinated Multi-Point (CoMP) measurement set/cooperating set, comprising:
a measurement report receiving device receiving an enhanced Reference Signal Received Power (eRSRP) measurement report, wherein the measurement report is about eRSRP of Channel State Information-Reference Signals (CSI-RSs) of multiple transport points measured based on measurement configuration; and
a measurement set/cooperating set maintaining device maintaining the measurement set/cooperating set based on the received eRSRP measurement report.

25. The base station according to claim 24, wherein a measurement event in the measurement configuration is determining whether the eRSRP of the CSI-RS of the measured transport point is better than a threshold, or determining whether the eRSRP of the CSI-RS of the measured transport point is higher than strongest eRSRP by a preset offset.

26. The base station according to claim 24, wherein a measurement event in the measurement configuration is a measurement event A2, A3 or A4 based on protocol TS36.331, and the measurement configuration comprises indication information for CSI-RS measurement.
